(19) United States
(12) Patent Application Publication
(10) Pub. No.: US 2002/0114407 A1
(43) Pub. Date: Aug. 22, 2002

(54) Clock and data recovery unit with loss of signal and error detection

(76) Inventors: Vladimir Katzman, Rancho Palos Verdes, CA (US); Richard N. Nottenburg, Princeton, NJ (US); Sean Woyciechowsky, Marina Del Rey, CA (US); Yaozhong Liu, (US); David Scott Farkas, (US); Loc Binh Chau, (US); Andres John Bonthron, (US); Christopher Joseph Clark, (US)

Correspondence Address: Douglas A. Chaikin, PENINSULA IP GROUP, Suite 101, 2290 North First Street, San Jose, CA, 95131, US

(21) Appl. No.: 09/791,429

(22) Filed: Feb. 21, 2001

(51) Int. Cl. H04L 27/14

(52) U.S. Cl. 375/326; 375/224

(57) ABSTRACT

Apparatus for recovering clock and data signals from received transmission line information and for regenerating the recovered clock and data signals and for detecting a loss of signal and predicting a probability of noise in a transmission system from errors occurring in the received transmission line information.

### FIELD OF THE INVENTION

The present invention relates to digital data communication apparatus and in particular to apparatus and to a method for generating clock and data signals and detecting loss of signal and predicting a probability of noise in received transmission line information.

### BACKGROUND OF THE INVENTION

Transmission systems generally have transmitter/receiver apparatus and a transmission facility or line interconnecting the transmitter/receiver apparatus and providing a path over which data may be exchanged between the transmitter/receiver apparatus. Increasing advances in technology and the need for more information require greater speed in the rate of transmitting data. The technology has went from analog systems to digital information systems capable of transmitting digital information in the form of logical “0's” and “1's” oftentimes referred to as bits. In an effort to increase the speed of transmission systems, the technology has advanced to the use of optical transmission systems using optical transmitter/receivers interconnected by optical transmission facilities such as optical fibers that transmit optical pulse bit information between the optical transmitter/receivers.

Digital transmitters and receivers are oftentimes connected by long transmission facilities. Typically, a digital transmitter applies binary digital signal information to the transmission facility which is then sent to the receiver which is designed to receive and decode data contained within the received information. The characteristics of the transmission line often times deforms the waveform format of the transmitted information such that the transmitted information is meaningless when it is received by the distant receive. Thus, digital and optical transmission systems oftentimes have transmitter/receiver devices connected by transmission facilities which may have optical clock and data regenerative units or repeaters located in the transmission facilities between the transmitters and receivers. The clock and data regenerative recovery units are used to restore data transmitted through long transmission facilities.

A problem arises that in order to have high quality of the data with error corrections therein it is necessary to regenerate the clock signals used to transmit the information and to recover the data in the transmission line information received by the regenerative recovery units. Usually, the correlation function of a noise signal occurring in the transmission line facility and the apparatus connected thereto is close to the correlation function of the transmitted information. In addition to recovering the clock and data of the received information, it is very important to ascertain an accurate detection of loss of the signal on the transmission facility in order to preserve a high reliability of the digital system. Thus, it is desirable to provide apparatus and a method for regenerating clock signals and data from information received over a transmission facility and for determining a bit error rate in order to predict noise occurring on the transmission facility.

### SUMMARY OF THE INVENTION

It is an object of the invention to provide apparatus for recovering clock and data signals from received transmission line information and for regenerating the recovered clock and data signals and for detecting a loss of signal and prediction of noise occurring in the received transmission line information.

It is also an object of the invention to provide apparatus for recovering clock and data signals from received transmission line information wherein the apparatus has clock detecting apparatus for recovering and generating a clock signal and a loss of the clock signal from the received transmission line information.

It is also an object of the invention to provide apparatus for recovering clock and data signals from received transmission line information wherein the apparatus has data detecting apparatus for recovering and generating data signals from the received transmission line information and for detecting errors occurring in the received transmission line information.

It is also an object of the invention to provide apparatus for recovering clock and data signals from received transmission line information wherein the apparatus has a central processing unit connected to clock detecting apparatus for controlling the clock apparatus to vary a clock phase of a generated clock signal and connected to data detecting apparatus for controlling the data detecting apparatus to distinguish between data and errors and predict a probability of the noise occurring in the received transmission line information.

It is also an object of the invention to provide apparatus for recovering clock and data signals from received transmission line information wherein the apparatus has clock detecting apparatus for receiving the transmission line information and determining a spectral power density therefrom defining clock information.

It is also an object of the invention to provide apparatus for recovering clock and data signals from received transmission line information wherein the apparatus has data detecting apparatus for recovering and generating data signals from the received transmission line information and for determining a signal height of the received transmission line information to detect errors occurring in the received transmission line information.

In a preferred embodiment of the invention, apparatus recovers and generates clock and data signals from received transmission line information. Receiving apparatus receives the transmission line information and splits the received transmission line information into multiple identical transmission line information. Clock detecting apparatus connected to the receiving apparatus recovers and generates a clock signal from the received transmission line information and generates a loss of clock signal upon loss of the clock signal. Data detecting apparatus connected to the receiving means recovers and generates data signals from the received transmission line information and detects errors occurring in the received transmission line information. A central processing unit connected to the clock detecting and data detecting apparatus varies a clock phase of the generated clock signal, distinguishes between data and errors and predicts a probability of noise occurring in the received transmission line information.

Also in accordance with the preferred embodiment of the invention, apparatus for recovering and generating clock and data signals from received transmission line information has clock detecting apparatus for recovering and generating a clock signal from the received transmission line information and for generating a loss of clock signal upon loss of the generated clock signal.

Also in accordance with the preferred embodiment of the invention, apparatus for recovering and generating clock and data signals from received transmission line information has data detecting apparatus for recovering and generating positive and negative data signals from the received transmission line information and for detecting errors occurring in the received transmission line information.

Also in accordance with the preferred embodiment of the invention, apparatus for recovering and generating clock and data signals from received transmission line information has a central processing unit connected to clock detecting apparatus for varying a clock phase of generated clock signals and to data detecting apparatus for distinguishing between data and errors and for predicting a probability of noise occurring in the received transmission line information from error information.

Also in accordance with the preferred embodiment of the invention, a method for recovering and generating clock and data signals from received transmission line information comprises the steps of splitting the received transmission line information and generating a spectral power density containing clock signal information from the received transmission line information. The method also comprises the steps of determining a loss of signal indication in response to loss of the generated spectral density information, generating the clock signals in response to receipt of the spectral density information and detecting a loss of the generated clock signals. The method also comprises the steps of generating positive and negative data signals from the received transmission line information and detecting errors occurring in the received transmission line information. The method further comprises the steps of varying a clock phase of the generated clock signals and distinguishing between data and errors and predicting a probability of noise occurring in the received transmission line information from the errors.

### BRIEF DESCRIPTION OF THE DRAWINGS

For a further understanding of the objects and advantages of the present invention, reference should be had to the following detailed description, taken in conjunction with the accompanying drawing figures, in which like parts are given like reference numerals and wherein:

FIG. 1 is a block diagram of clock and data recovery apparatus with loss of signal and error detection in accordance with principles of the invention,

FIG. 2 is a block diagram of the clock detector components of the clock and data recovery apparatus set forth in FIG. 1,

FIG. 3 is a block diagram of the data detector components of the clock and data recovery apparatus set forth in FIG. 1,

FIG. 4 is a schematic diagram of the splitter components of the clock and data recovery apparatus set forth in FIGS. 1 and 3, and

FIG. 5 is a block diagram of the digital differentiator component of the clock and data recovery apparatus set forth in FIGS. 1 and 2.

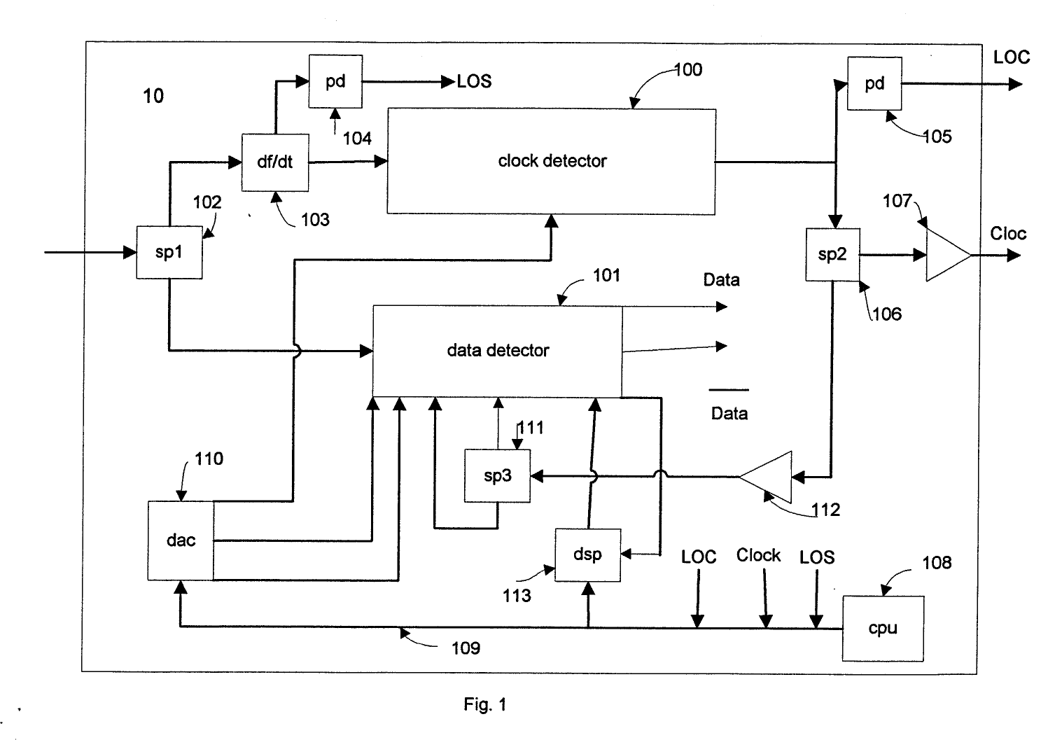

The detailed logic circuitry of the clock and data recovery apparatus set forth in FIGS. 1 through FIG. 5 of the drawing is performed by amplifiers, logic gates, flip flops, wide and narrow band splitters, variable delay lines, peak detectors, digital differentiators, filters, comparators, digital to analog converters and central processing units, the individual operation of which are well known in the art and the details of which need not be disclosed for an understanding of the invention. Typical examples of the logic circuitry are described in numerous textbooks. For example, such types of logic circuitry, among others, are described by J. Millman and H, Taub in Pulse, Digital and Switching Waveforms, 1965, McGraw-Hall, Inc., H. Alex Romanowitz and Russell E. Puckeft in Introduction to Electronics, 1968, John Wiley & Sons, Inc. and in The TTL Data Book for Design Engineers, Second Edition, 1976, Texas Instruments Incorporated.

### DETAILED DESCRIPTION OF THE INVENTION

With particular reference to FIG. 1, there is shown clock and data signal recovery and generating apparatus 10, in accordance with the principles of the invention, for use in a digital data transmission system such an optical communication transmission system to recover clock and data signals received as information over an optical fiber or other path of a transmission facility. Apparatus 10 recovers and regenerates clock and data signals from the received information for retransmission by a repeater over another optical fiber or for use by a receiver unit connected to the transmission facility. In addition, clock and data signal recovery and generating apparatus 10 detects a loss of the received transmission line information and clock signal and records a probability of noise appearing in the received information from errors detected in the received transmission line information. Although digital information in the form of logical “0's” and “1's” is transmitted on the transmission facility, the characteristics of the transmission facility deforms the format of the transmitted line information thereby requiring that the information received on a long transmission facility be regenerated before being retransmitted on another transmission facility or applied to a receiver.

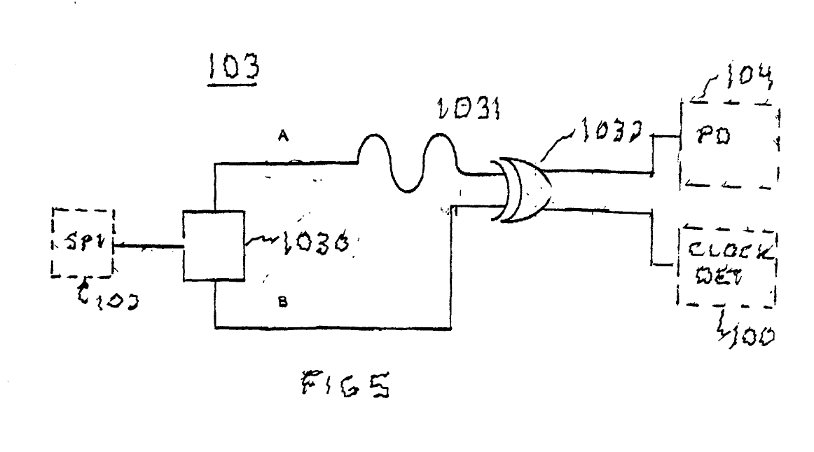

The information received over an incoming transmission facility is received at an input resistance R1 of wide band splitter 102, FIG. 4, of the clock and data signal recovery and generating apparatus 10 and applied over two output ports one of which is connected through resistance R3 to the clock detector 100, FIG. 1, through digital differentiator 103 and the other connected through resistance R2 to data detector 101. Digital differentiator 103, FIG. 5, connected to one of the wide band splitter 102 outputs, receives the transmission line information and converts the received information into waveforms A and B via circuitry 1030. Waveform A is delayed by circuitry 1031 and the delayed waveform A and waveform B are applied to exclusive OR gate 1032 to obtain polarities of a spectral power density of the received transmission line information containing clock information. One output port of digital differentiator 103, FIG. 1, is connected to peak detector 104 that is responsive to the output spectral density information such that the loss of the received transmission line information and the resulting loss of a first polarity of the spectral power density output of digital differentiator 103 is recorded as a loss of signal (LOS).

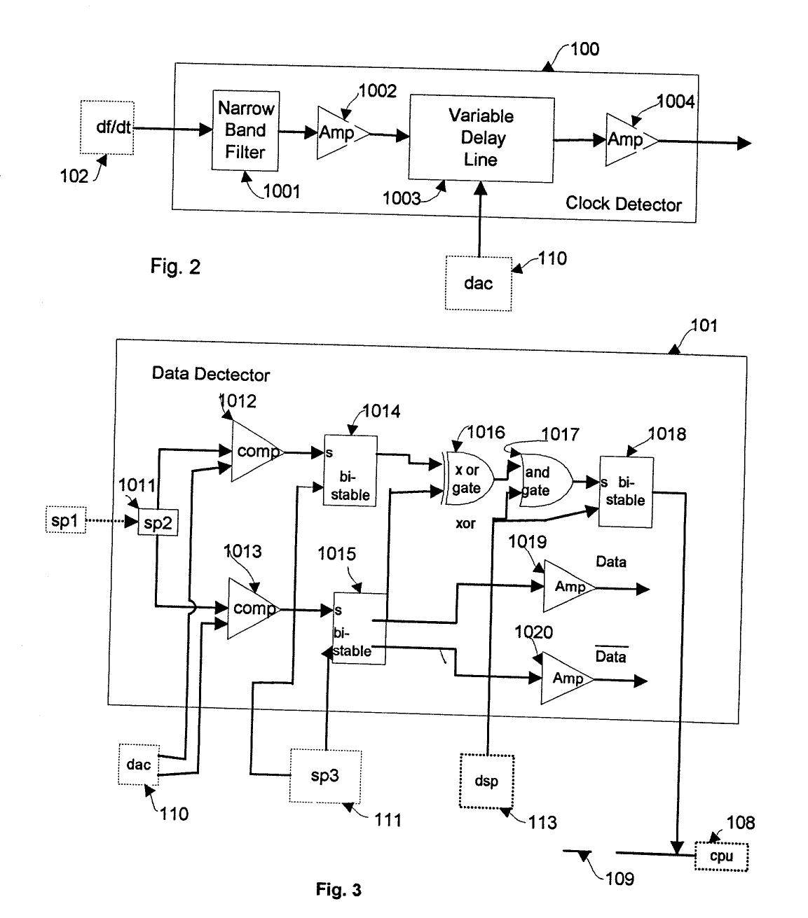

As set forth in FIG. 2, the clock detector 100 has a narrow band filter 1001 and a narrow band amplifier 1002 with an output of the narrow band filter 1002 connected to a variable delay line 1003. The input of the narrow band filter 1001 is connected to an output of the digital differentiator 103 for generating the clock signal in response to receipt of the spectral density information. In operation, digital differentiator 103 generates spectral density information from the received transmission line information. This information is then filtered by the narrow band filter 1001 to generate a clock signal used to generate the received transmission line information at the distant end of the transmission line facility. The clock signal generated in response to the spectral density information is than amplified by the narrow band amplifier 1002 and applied to the input of the variable delay line 1003.

Variable delay line 1003, which may be any one of a number of delay lines well known in the art, is connected to an output of the digital-to-analog converter 110, FIG. 1, which in turn is connected by a bus 109 to a central processing unit 108. In operation, central processing unit 108 is programmed to send addressed digital instructions over bus 109 to the digital-to-analog converter 110. The digital-to-analog converter 110 responds to receipt of the instructions by converting the digital instructions to analog information which is then applied to the delay line 1003 to vary the phase of the clock signal generated from the received transmission line information. Another narrow band amplifier 1004, FIG. 2, is connected to an output of the variable delay line 1003 for amplifying the clock signal output of the variable delay line 1003. The generated clock signal output of amplifier 1004 is applied both to a peak detector 105, FIG. 1, and a narrow band splitter 106. Peak detector 105 detects a loss of the regenerated clock signal and notifies the central processing unit 108 when this occurs. Narrow band splitter 106, connected to amplifier 107, makes the generated clock pulses available to the central processor 108, a receiver or to another transmitter, not shown, which may be connected to another transmission line facility. The narrow band splitter 106 also applies the generated clock signal to another narrow band splitter 111 via amplifier 112 which in turn applies the generated clocks pulses to the data detector 101.

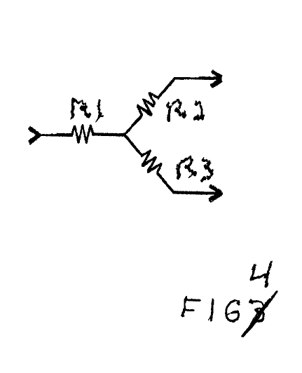

An output of wide band splitter 102 is also connected to an input of another wide band splitter 1011 to apply the received transmission line information to the data detector 101, FIG. 3. The outputs of wide band splitter 1011 are each connected to an input of one of the comparator circuits 1012 and 1013. The other input of the comparator circuits 1012 and 1013 are coupled to outputs of digital-to-analog circuit 110 which in turn is connected by bus 109 with central processing unit 108, FIG. 1.

On the transmission line facility coupled with clock and data signal recovery and generating apparatus 10, there may also be undesirable noise combined with the transmitted transmission line information. Typically, the noise appearing at the inputs of the wide band splitter apparatus 102, 1011, FIG. 3, of clock and data signal recovery and generating apparatus 10, is at different voltage levels than that of the received transmission line information. Thus, central processing unit 108 is programmed to detect errors and determine a probability of noise appearing in the received transmission line information by applying different levels of voltage individually to the inputs of comparator circuits 1012 and 1013. The voltage level information is transmitted on bus 109, FIG. 1, by central processing unit as digital information addressed to the appropriate comparator circuits 1012 and 1013, FIG. 3, via digital-to-analog circuit 110. The digital-to-analog unit 110 converts the digital information into analog voltages which are then applied to comparator circuits 1012 and 1013 such that different voltage levels are applied to each input.

The output of comparator 1013 is connected to the set input of bistable device 1015 so that the portion of the received transmission line information that has a potential higher then the analog control signal applied to comparator 1013 sets bistable device 1015. The generated clock signals amplified by amplifier 112 and applied from the output of narrow band splitter 111 to the reset terminal of bistable device 1015 resets the bistable device 1015 when the received transmission information potential is lower than the comparator 1013 analog control signal. The set output of bistable device 1015 is the regenerated data in a positive format that is amplified by amplifier 1019 and is available for use by a repeater transmitter for retransmission on another transmission facility or for use by a terminal receiver. The reset output of bistable device 1015 is the regenerated data in a negative format that is amplified by amplifier 1020 and is available for use by the repeater transmitter or terminal receiver. Thus, data detector 101 regenerates both a positive and negative format of the data.

Comparator circuits 1012 and 1013, each connected to one of a pair of outputs of the second wide band splitter circuit 1011 and each individually controlled by the central processor unit 108 determine a signal height of the received transmission line information. When positive pulses of the received transmission line information appear at the input of comparator circuits 1012 and 1013, the bistable devices 1014 and 1015 both apply the same output signal to the exclusive-OR gate 1016 thereby generating a logical “0” output and applying the “0” output to the input of AND gate 1017. When a zero input is applied to both inputs, AND gate 1017 applies a zero output signal to the set input of bi-stable device 1018 which responds to a reset signal generated by the i5 digital signal processor 113, FIG. 1, in response to a command from central processing unit 108 by sending a zero signal to the central processing unit 108 as a no error signal indication.

When noise occurs in the received transmission line information, it may occur during the time interval when there should be a logical “0” signal in the received transmission line information. Depending on the level of the analog signals applied to comparator gates 1012 and 1013, comparator gate 1012 may operate to apply a signal to the set terminal of bistable device 1014 while comparator gate 1013 remains unoperated. Thus, there is a logical “1” and “0” applied to the inputs of exclusive or gate 1016 resulting in a logical “1” being applied to the set terminal of bistable device 1018. Bistable device 1018 responds by applying a logical “1” via bus 109 to central processor unit 108 thereby indicating that an error has occurred in the received transmission line information. Central processor unit 108, programmed for controlling operation of the clock and data signal generating apparatus 10, is also programmed to determine a probability of noise occurring in the received transmission line information upon receiving the error information generated by data detector 101.

In a transmission system, information is transmitted from a transmitter over a transmission facility or line to a receiver. On a long transmission line there may be a need for a repeater located within or at the end of the transmission line to recover and generate clock and data signals from the transmission line information. In accordance with the principles of the instant invention, the method for recovering and generating the clock and data signals from the received transmission line information comprises the steps of splitting the received transmission line information and generating a spectral power density containing clock signal information from the splitted received transmission line information. The method generates the clock signals in response to receipt of the spectral density information and is able determine a loss of signal indication in response to loss of the generated spectral density information and detects a loss of the generated clock signals. The method, which may be used at a repeater or at a system receiver, generates positive and negative data signals from the received transmission line information and detects errors occurring in the received transmission line information. The method also comprises the steps of varying a clock phase of the generated clock signals and distinguishing between data and noise and predicting a probability of noise occurring in the received transmission line information from the detected errors.

It is obvious from the foregoing that the facility, economy and efficiently of optical and digital transmission systems is improved by apparatus for recovering and generating clock and data signals from received transmission line information and for generating a loss of received information and clock signals and for detecting errors in received transmission information and predicting a probability of noise from errors occurring in the received transmission line information. While the foregoing detailed description has described an embodiment of clock and data signal recovery and generating apparatus and a method of operation thereof in accordance with principles of the invention, it is to be understood that the above description is illustrative only and is not limiting of the disclosed invention. Particularly other configurations of time delay, voltage comparator, digital-to-analog and control apparatus are within the scope and sprit of this invention. Thus, the invention is to be limited only by the claims set forth below.

What is claimed is:

1. Apparatus for recovering and generating clock and data signals from received transmission line information comprising
clock detecting means for recovering and generating a clock signal from the received transmission line information,
data detecting means enabled by the recovered clock signal for recovering and generating data contained in the received transmission line information , and
detector means for detecting a loss of signals and errors and for predicting noise from errors occurring in the transmission line information.

2. The clock and data signal recovery and generating apparatus set forth in claim 1 further comprising
wide band splitting apparatus having an input for receiving the transmission line information and outputs for applying the received transmission line information to both the clock and data detecting means.

3. The clock and data signal recovery and generating apparatus set forth in claim 2 further comprising
a digital differentiator connected to one of the outputs of the wide band splitting apparatus for receiving the transmission line information and determining a spectral power density of the received transmission line information.

4. The clock and data signal recovery and generating apparatus set forth in claim 3 further comprising
a peak detector connected to an output of the digital differentiator and responsive to the output spectral density information generated thereby for determining an absence of the spectral power density as a loss of signal indication.

5. The clock and data signal recovery and generating apparatus set forth in claim 4 further comprising
another peak detector connected to an output of the clock detecting means for detecting a loss of the clock signal.

6. The clock and data signal recovery and generating apparatus set forth in claim 5 wherein the clock detecting means comprises
a narrow band filter and amplifier having an input connected to another output of the digital differentiator for generating the clock signals in response to the spectral power density information.

7. The clock and data signal recovery and generating apparatus set forth in claim 6 wherein the clock detecting means comprises
variable delay means connected to the narrow band filter and amplifier for varying a phase of the clock signal generated from the spectral power density.

8. The clock and data signal recovery and generating apparatus set forth in claim 7 wherein the clock detecting means comprises
another narrow band amplifier connected to an output of the variable delay means for amplifying the clock signal output thereof.

9. The clock and data signal recovery and generating apparatus set forth in claim 8 further comprising
narrow band splitter apparatus having an input connected to the other narrow band amplifier of the clock detecting means for splitting the generated clock signal.

10. The clock and data signal recovery and generating apparatus set forth in claim 9 further comprising
a pair of narrow band amplifiers each connected to an output port of the narrow band splitter apparatus for amplifying the generated clock signal.

11. The clock and data signal recovery and generating apparatus set forth in claim 10 wherein the wide band splitting apparatus comprises
a first wide band splitter circuit having an input for receiving the transmission line information and wherein the first wide band splitter circuit splits the received transmission line information and connects the split received transmission line information to a pair of outputs.

12. The clock and data signal recovery and generating apparatus set forth in claim 11 wherein the wide band splitting apparatus further comprises
a second wide band splitter circuit having an input connected to one of outputs of the first wide band splitter circuit for receiving the split received transmission line information and applying the received split transmission line information to the data detecting means.

13. The clock and data signal recovery and generating apparatus set forth in claim further comprising
a central processor unit for controlling operation of the clock and data detecting means and for determining a probability of noise occurring in the received transmission line information.

14. The clock and data signal recovery and generating apparatus set forth in claim 13 wherein the data detecting means comprises
a pair of comparator circuits each connected to one of a pair of outputs of the second wide band splitter circuit and each individually controlled by the central processor unit for determining a signal height of the received transmission line information.

15. The clock and data signal recovery and generating apparatus set forth in claim further comprising
digital-to analog means coupled with the clock detecting means variable delay means and with the data detecting means comparator circuits and controlled by the central processing unit to control phases of the generated clock signal and individual voltage levels of the pair of comparator circuits.

16. The clock and data signal recovery and generating apparatus set forth in claim wherein the data detecting means further comprises
a first bistable device having one input receiving a first voltage level of the received transmission line information output of a first one of the comparators and another input receiving the generated clock signal for regenerating both a positive and negative format of the data.

17. The clock and data signal recovery and generating apparatus set forth in claim 16 wherein the data detecting means further comprises
a second bistable device having one input receiving a second voltage level of the received transmission line information output of a second one of the comparators and another input receiving the generated clock signal for determining errors in the received transmission line information.

18. The clock and data signal recovery and generating apparatus set forth in claim 17 wherein the data detecting means further comprises
a first logic means connected to first outputs of the first and second bistable means for determining a presence of signals of the received transmission line information having a voltage potential between the first and second voltage levels.

19. The clock and data signal recovery and generating apparatus set forth in claim 18 wherein the data detecting means further comprises second logic means connected to the output of the first logic means and enabled by the generated clock signal for recording the detected errors in the received transmission line information.

20. The clock and data signal recovery and generating apparatus set forth in claim 19 further wherein the central processing unit is connected to the second logic means for predicting a probability of noise occurring in the received transmission line information from the detected errors.

21. Apparatus for recovering and generating clock and data signals from received transmission line information comprising
receiving means for splitting the received transmission line information,
clock detecting means connected to the receiving means for recovering and generating a clock signal from the received transmission line information and for generating a loss of clock signal upon loss of the clock signal,
data detecting means connected to the receiving means for recovering and generating data signals from the received transmission line information and for detecting errors occurring in the received transmission line information, and
a central processing unit connected to the clock detecting means for varying a clock phase of the generated clock signal and to the data detecting means for distinguishing between data and errors and for predicting a probability of noise occurring in the received transmission line information from the errors.

22. The clock and data signal recovering and generating apparatus set forth in claim further comprising
digital differentiator means connected to the receiving means for determining a spectral power density of the received transmission line information containing clock signal information.

23. The clock and data signal recovering and generating apparatus set forth in claim wherein the clock detecting means comprises
a narrow band filter and amplifier connected to a variable delay line and having an input connected to an output of the digital differentiator means for generating the clock signal in response to receipt of the spectral density information.

24. The clock and data signal recovering and generating apparatus set forth in claim 23 wherein the data detecting means comprises
a pair of comparator circuits each connected to the receiving means and to logic means and controlled by the central processing unit for generating both a positive and negative format of the data and for detecting errors occurring in the received transmission line information and enabling the central processing unit to predict the probability of the noise occurring in the received transmission line information.

25. The clock and data signal recovering and generating apparatus set forth in claim 24 further comprising
a peak detector connected to the digital differentiator and responsive to loss of the output spectral density information generated thereby for determining a loss of signal indication.

26. The clock and data signal recovering and generating apparatus set forth in claim 21 further comprising
a peak detector connected to an output of the clock detecting means for detecting a loss of the clock signal.

27. Apparatus for recovering and generating clock and data signals from received transmission line information comprising
receiving means for splitting the received transmission line information,
digital differentiator means connected to the receiving means for determining a spectral power density of the received transmission line information containing clock signal information,
first peak detector means connected to the digital differentiator means and responsive to loss of the output spectral density information generated thereby for determining a loss of signal indication,
narrow band filter and amplifier means connected to variable delay line means and having an input connected to an output of the digital differentiator means for generating the clock signal in response to receipt of the spectral density information,
second peak detector means connected to an output of the narrow band filter and amplifier and variable delay line means for detecting a loss of the clock signal,
data detecting means connected to the receiving means for recovering and generating positive and negative data signals from the received transmission line information and for detecting errors occurring in the received transmission line information, and
central processing means connected to the variable delay line means for varying a clock phase of the generated clock signal and to the data detecting means for distinguishing between data and noise and for predicting a probability of noise occurring in the received transmission line information from the detected errors.

29. A method for recovering and generating clock and data signals from received transmission line information comprising the steps of
splitting the received transmission line information,
generating a spectral power density containing clock signal information from the splitted received transmission line information,
determining a loss of signal indication in response to loss of the generated spectral density information,
generating the clock signals in response to receipt of the spectral density information,
detecting a loss of the generated clock signals.
generating positive and negative data signals from the received transmission line information and detecting errors occurring in the received transmission line information, and
varying a clock phase of the generated clock signals and distinguishing between data and errors and predicting a probability of noise occurring in the received transmission line information from the detected errors.
